(19) United States
(12) Patent Application Publication
(10) Pub. No.: US 2026/0217477 A1
(43) Pub. Date: Jul. 30, 2026

(54) METHOD AND APPARATUS FOR SORTING CLOSING ELEMENTS WITH A TRANSPORT SYSTEM HAVING MOVABLE HOLDING ELEMENTS

(71) Applicant: RONCHI MARIO S.P.A., GESSATE (IT)

(72) Inventor: CESARE RONCHI, GESSATE (IT)

(21) Appl. No.: 19/146,999

(22) PCT Filed: Feb. 6, 2024
(86) PCT No.: PCT/IB2024/051067

§ 371 Date: Jul. 10, 2025

(30) Foreign Application Priority Data
Feb. 7, 2023 (IT) 102023000002034
Feb. 7, 2023 (IT) 102023000002049
Feb. 7, 2023 (IT) 102023000002055

(51) Int. Cl. B65G 47/24; B65G 17/32; B65G 47/68; B65G 47/90

(52) U.S. Cl. CPC B65G 47/24; B65G 17/323; B65G 47/682; B65G 47/902

(57) ABSTRACT

Amendments to the abstract were made herewith to correct minor informalities with the parent application. A clean copy of the abstract is included herewith on a clean sheet. Even in light of the amendments no new matter is being added and all amendments are fully supported by the specification as filed.

The present invention relates to a transport system for transporting closing elements with movable holding elements and a sorting apparatus for sorting randomly fed closing elements comprising the transport system.

It is known in the technical sector relating to the packaging of products, for example in liquid, fluid or powder form, that there exists the need to fill, with the desired product, containers which have different capacities and shapes and then close the filled container with a respective closing element.

For this purpose, automatic filling and capping machines are known, these being designed to fill, close and then forward the filled containers for packaging.

It is also known that these automatic machines must generally be supplied continuously, at a regular pitch and/or at a constant speed, these parameters being determined by the requirements of the said machines.

For this purpose, feeding apparatus—conventionally called “sorting machines”—have been developed, these apparatus being able to feed containers, which are initially arranged randomly inside special hoppers, in an orderly sequence to said downstream operating machines.

In the technical sector of filling/capping machines with a high production speed, which are generally of the rotating type, there exists the further problem of feeding the closing elements for capping the containers to the input of the filling/capping machine, which generally requires an orderly flow of closing elements arranged with a predefined orientation and/or position (e.g. upright position).

The sorting of the closing elements for closing the containers poses more complex problems than the sorting of the containers, since the closing elements, differently from other articles such as bottles, may have geometric forms such that many different positions and arrangements (orientations) are possible when the closing elements are fed randomly on a transport system such as a conveyor belt. In addition, some closing elements are unable to remain self-supporting in a predefined stable position, in particular in an upright position.

In this context it is also known that different types and formats of closing elements exist. For the purposes of the description of the present invention, for the sake of simplicity, three main types of closing element are identified, i.e. caps, sprayers (or dispensers) and triggers.

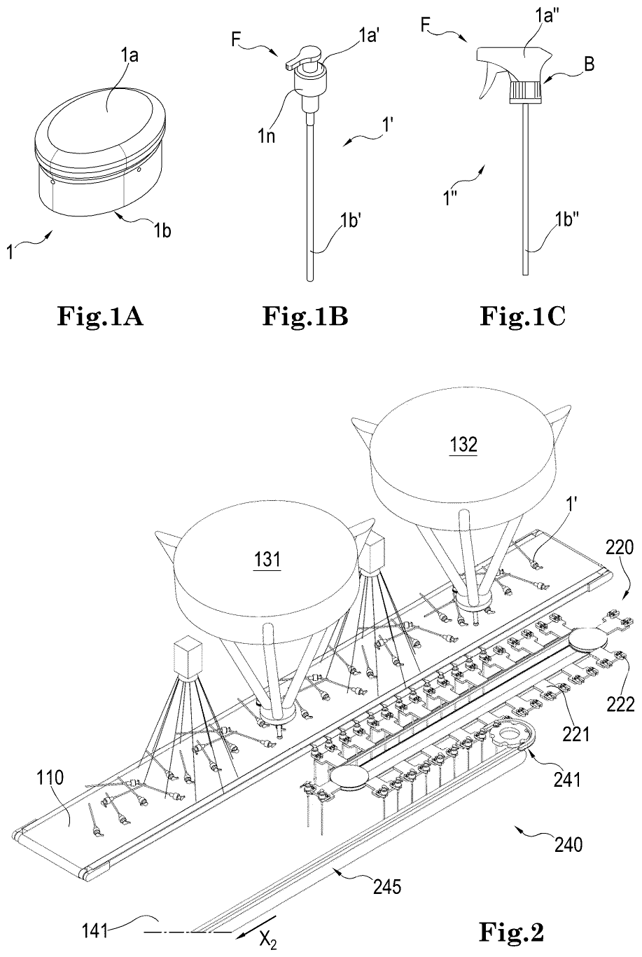

FIG. 1a shows an example of a closing element in the form of a cap 1, with a top head 1a and a bottom cavity 1b arranged opposite each other along a main vertical axis and connected by a side surface with a substantially elliptical cross-section.

FIG. 1b shows an example of a closing element of the sprayer 1′ or dispenser type, which has a top head 1a′, a neck In situated underneath the head 1a′ and a bottom stem 1b′ with a vertical axis.

FIG. 1c shows an example of a closing element of the trigger type 1″ which has a top head 1a″ and a bottom stem 1b″ with a vertical axis.

In the case of the sprayer 1′ and the trigger 1″, a front side F-conventionally assumed as being that with the dispensing mouth- and an opposite rear side B are also identified.

In the context of the present invention, reference will be generally made to the position of the closing element when referring the orientation of its main (vertical) axis, understood as corresponding to the axis of insertion onto the mouth of the container onto which it must be fitted. The position may in particular be vertically upright, laid flat on a plane perpendicular to the vertical direction, or inclined at an angle with respect to these two positions.

Reference will instead be generally made to an orientation of the closing element in order to refer to a specific orientation of its elements (head, bottom) and/or its surfaces (conventionally identified as front, side, rear in relation to the main vertical axis).

These definitions are however proposed here only for the sake of easier description and do not have a limiting meaning.

In most of the applications, in order to allow correct application of the closing element onto the associated container, the closing elements must be fed to the downstream filling/capping machines always in a certain position, generally vertical upright position, and/or with a specific orientation of its elements (head, bottom) and/or its surfaces, in relation to a vertical axis, to the position of the head and/or to the direction of feeding through the machine.

According to particular aspects of the present invention, for the types of closing elements shown in FIGS. 1a-1c, the following predefined position/orientation is preferred:
a. Caps: upright position with head (continuous upper surface) directed upwards;
b. Sprayers: vertical upright position with head directed upwards. The front side F with dispenser may be oriented in any direction, preferably the rear side B is directed towards the extraction direction;
c. Triggers: vertical upright position with head directed downwards and rear side B directed towards the extraction direction.

The transport of closing elements with sprayers or trigger poses numerous problems with regard to the design of sorting apparatus for use in container filling and capping plants, for example because, on conventional conveyor belts, it is not easy to transport closing elements of this type in a predefined position and/or with a predefined orientation.

Examples of sorting apparatus and/or transport system according to the preamble of claim 1 or 30 are described into CA 3 191 190.

A technical problem underlying the present invention, therefore, is that of providing a transport system for transporting closing elements which is suitable for transporting closing elements provided with a trigger or sprayer, in particular in a sorting apparatus for sorting the randomly fed closing elements so that they are fed to input devices of downstream operating machines, such as filling, capping or labelling machines, providing a solution to or at least partially overcoming one or more of the aforementioned problems of the prior art.

Another particular object of the present invention is that the transport system should be able to transport closing elements of a different type or format.

A further desirable aspect is that the transport system should be able to transport asymmetrical closing elements.

A further desirable aspect is that the transport system should be able to vary the orientation and/or the position of the closing elements during transport.

A further desirable aspect is that the transport system should be able to allow rapid modification of the format or type of closing elements to be transported, limiting to a minimum the format-changing operations and machine downtime.

Within the context of this problem, it is also desirable that the system should have small dimensions, be easy and inexpensive to produce and assemble and be able to be easily installed at any user location; in particular it is preferable that the transport system should allow the use of simple and fast devices, without negatively affecting the sorting efficiency.

A further particular object of the present invention is to provide a sorting method and a sorting apparatus which are able to sort randomly fed closing elements (sprayers, triggers) which must be fed to the downstream operating machines with a certain predefined position and/or orientation.

These objects are achieved by a transport system for transporting closing elements as described in the attached claims. The present invention relates furthermore to a method for sorting randomly fed closing elements and a sorting apparatus for sorting randomly fed closing elements, provided with a transport system.

According to a first aspect, the invention relates to a method for sorting closing elements for closing containers, comprising:
transporting a plurality of closing elements arranged randomly on an input conveyor plane;
picking up a plurality of the closing elements arranged randomly on the input conveyor plane by means of one or more pick and place devices, and positioning the picked-up closing elements with a predefined position and/or orientation in a positioning zone of a transport system for transporting closing elements, where they are received by a respective holding element of a plurality of holding elements for holding a closing element;
transporting the closing elements held by the holding elements to an exit part of the transport system.

The transport system comprises a plurality of support elements which each have a plurality of said holding elements, mounted on the support element and arranged at predetermined intervals along at least one side of the support element, and the support elements and the holding elements move along an oval circuit between the positioning zone and the exit part.

A further aspect of the invention relates to a sorting apparatus for sorting closing elements in accordance with claim 10.

In preferred embodiments, the holding elements are arranged on the respective support as a first series and at least one second series of holding elements and the pick and place devices are controlled so as to use a different series of holding elements for holding closing elements of a different format and/or for varying a pitch between the closing elements transported in the transport system.

In particular, the holding elements of the second series may be adapted and/or designated to hold closing elements of a different format from that of the holding elements of the first series. Furthermore, each support element may comprise a plurality of holding elements arranged at predetermined intervals on two opposite sides, wherein, in use, one of the opposite sides is operative and the other one is on standby.

The control unit may be configured to designate as active for sorting only some of said holding elements and to control the pick and place devices so that they position the closing elements only in said holding elements designated as active. Therefore, it is possible to carry out a format change of the transport system so as to transport a plurality of closing elements of a different format, designating for each support element a different series of holding elements for holding different closing elements and/or for varying a pitch between the closing elements transported in the transport system.

The method and the apparatus of the invention are particularly suitable for use in sorting closing elements of the sprayer type, having a top head with dispenser, a neck situated underneath the head and a bottom stem extending along a main vertical axis. In particular, the holding elements may hold a neck situated underneath the head of a respective sprayer, arranged in a vertical upright position with the head at the top.

The method and the apparatus of the invention are also particularly suitable for use in sorting closing elements having a top head with trigger and a bottom stem extending parallel to a main vertical axis of the closing element. Said closing elements with trigger head may be held in a position laid flat with the head directed towards the outside of the transport system.

In preferred embodiments of the apparatus, the oval circuit comprises a straight outward section, which includes the positioning zone, and a straight return section, which includes the exit part, said sections being connected by curved joining sections.

The support elements are preferably support plates movable along said circuit between the positioning zone and exit part. The support elements move preferably along a fixed guide which defines said oval circuit, on respective carriages.

In preferred embodiments, coupling means for coupling the support element to the carriage are configured to switch between a first operative position, in which the support element is rigidly secured to the carriage, and a second position, in which the support element is coupled to the carriage with the possibility of rotating about a vertical axis. Said switching is preferably performed by exerting a downwards pressure on the support element.

The support elements may each have coupling means for engagement with an auxiliary device for rotating the support element about a vertical axis. The auxiliary device for gripping and rotating the support elements may comprise an arm, the bottom end of which is movable in both senses of the vertical direction between a raised position and a lowered position for engagement with a support element and is provided with rotating means configured for stable engagement with the coupling means of the support element and able to be rotationally operated to rotate the element about a vertical axis so as to vary the arrangement thereof on the oval circuit. The auxiliary device may be arranged in a predefined position along the circuit for movement of the supports or may be displaceable from a position outside the circuit into a position situated above the circuit, by means of actuating means. Advantageously, the auxiliary device for rotating the support element may operate in the vertical direction on the support element so as to switch the coupling means of the support element to the guide for sliding between the first and second operative positions.

In preferred embodiments, a plurality of said holding elements is in the form of a gripper comprising a pair of opposite jaws; the jaws being preferably coupled together with interposed resilient means configured to bias them towards a relative closing position for holding the closing element. In other embodiments, a plurality of said elements for holding a closing element are in the form of a respective tray which defines an upwardly open compartment for housing the closing element. The tray may have a substantially U-shaped form, with a bottom plane for supporting a head of the closing element and two opposite vertical containing walls projecting upwards from the support plane and situated opposite each other in a transverse direction, parallel during use to the direction of a main axis of the closing element, wherein at least one wall is configured with a slot for inserting and holding a stem of the closing element.

In order to release the closing elements at the exit part, each tray may be provided with hinging means for rotation about a longitudinal axis, configured to allow rotation of the tray from a holding positioning into an overturned position, whereby the closing elements fall by means of gravity into a position rotated about a longitudinal axis through an angle greater than or equal to 90 degrees. Preferably, cam means are provided and are designed act on the tray in said exit part so as to cause an overturning rotation thereof and, downstream of the exit part, means are arranged for righting the trays.

In preferred configurations the closing elements are rotated through 180 degrees about a vertical axis when they are transported from the positioning zone at the input to the exit part for extraction.

Further details and technical advantages of the invention may be obtained from the following description of non-limiting examples of embodiment of the subject of the present invention, provided with reference to the attached drawings, in which:

FIG. 1A shows an example of a closing element in the form of a cap;

FIG. 1B shows an example of a closing element of the sprayer or dispenser type;

FIG. 1C shows an example of a closing element of the trigger type;

FIG. 2 shows an elevated perspective view of a first embodiment of a sorting apparatus for sorting closing elements in the form of sprayers, which includes a transport system used as intermediate transport system for the closing elements;

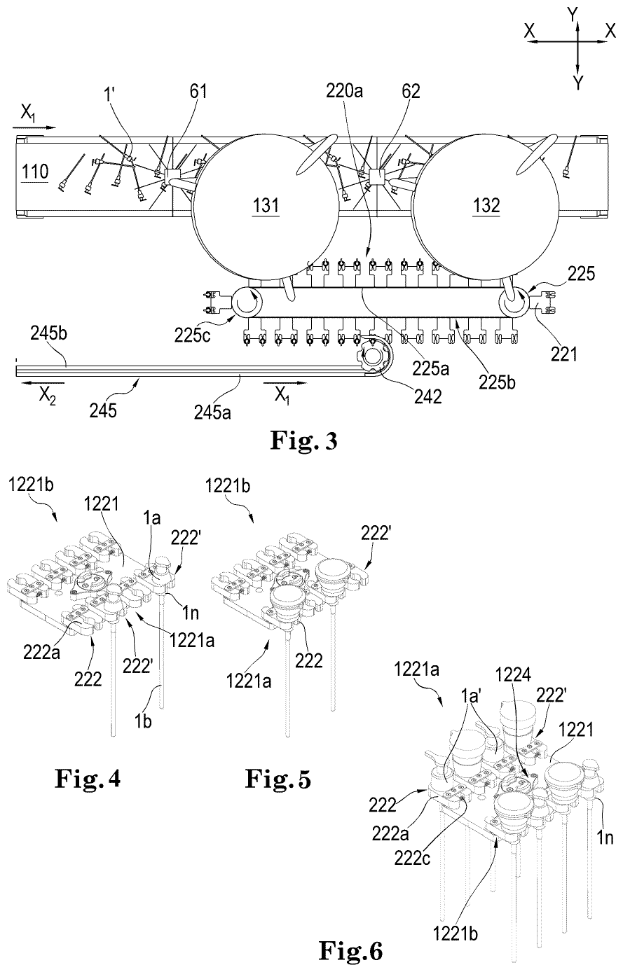

FIG. 3 shows a top plan view of the sorting apparatus according to FIG. 2;

FIG. 4 shows a perspective view of a preferred embodiment of a support plate, which carries a plurality of holding elements, with a series of holding elements gripping a respective closing element;

FIG. 5 shows the support plate according to FIG. 4 with a different series of holding elements gripping a respective closing element with a different format;

FIG. 6 shows the support plate according to FIG. 4 which carries a plurality of holding elements gripping closing elements of a different type and/or format;

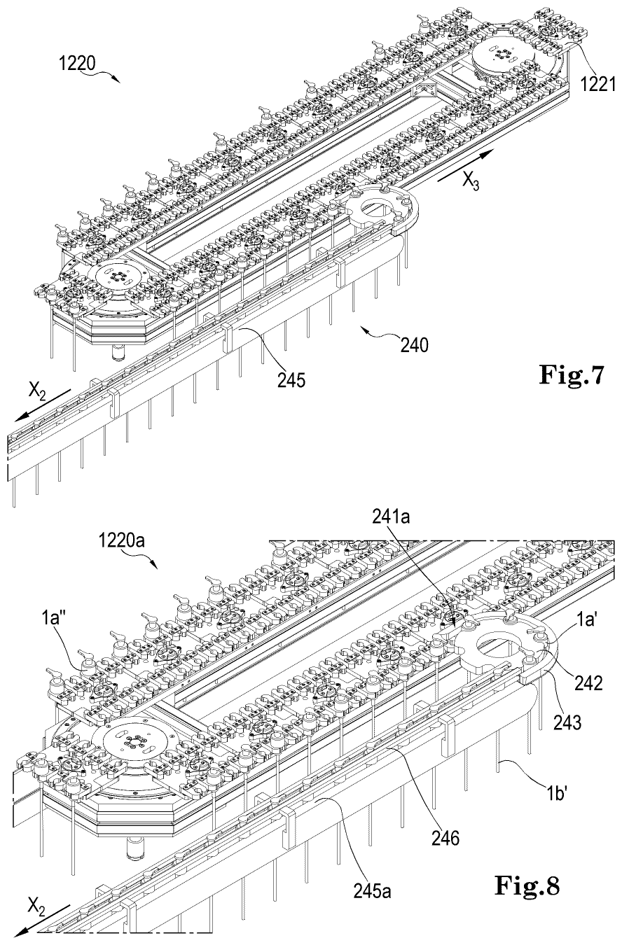

FIG. 7 shows a perspective view of a preferred variation of embodiment of the intermediate transport and extraction systems of the sorting apparatus according to FIG. 2;

FIG. 8 shows a partial enlarged view of the intermediate transport and extraction systems according to FIG. 7;

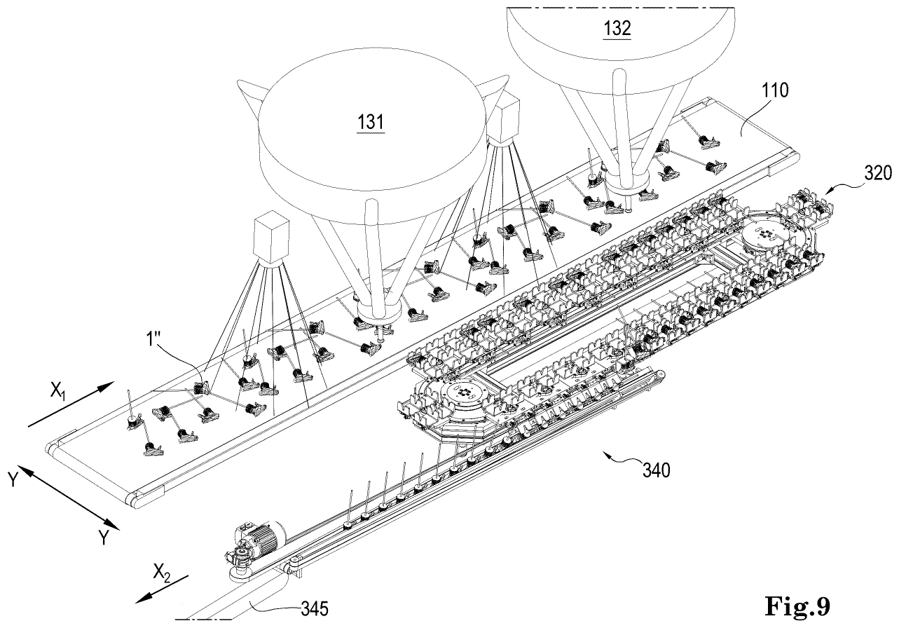

FIG. 9 shows a perspective view of a third embodiment of a sorting apparatus for sorting closing elements in the form of caps or triggers;

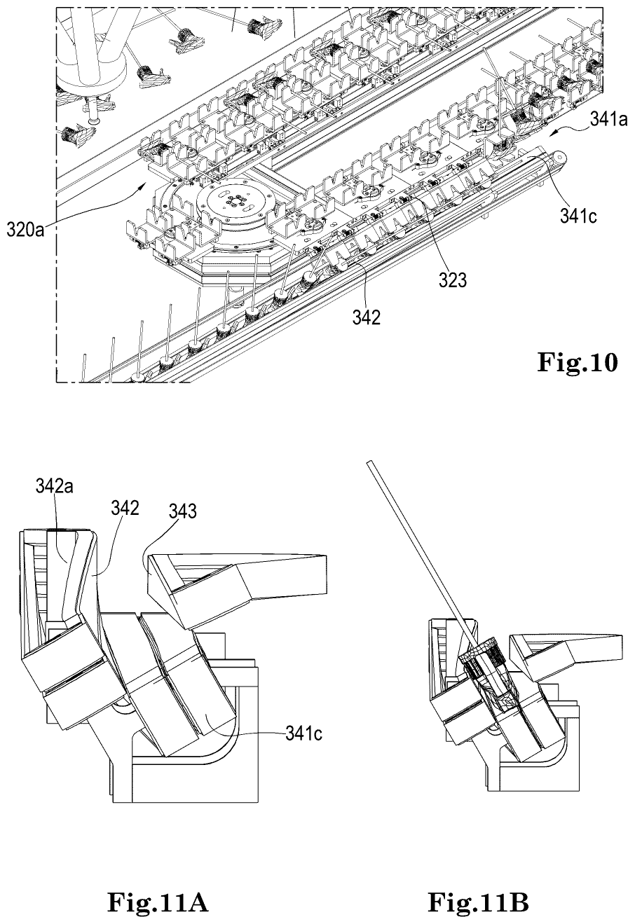

FIG. 10 shows a partial enlarged view of the intermediate transport and extraction systems of the apparatus according to FIG. 9;

FIGS. 11A, 11B show a rear view of the transition assembly of the transport system according to FIG. 10, without and with a trigger;

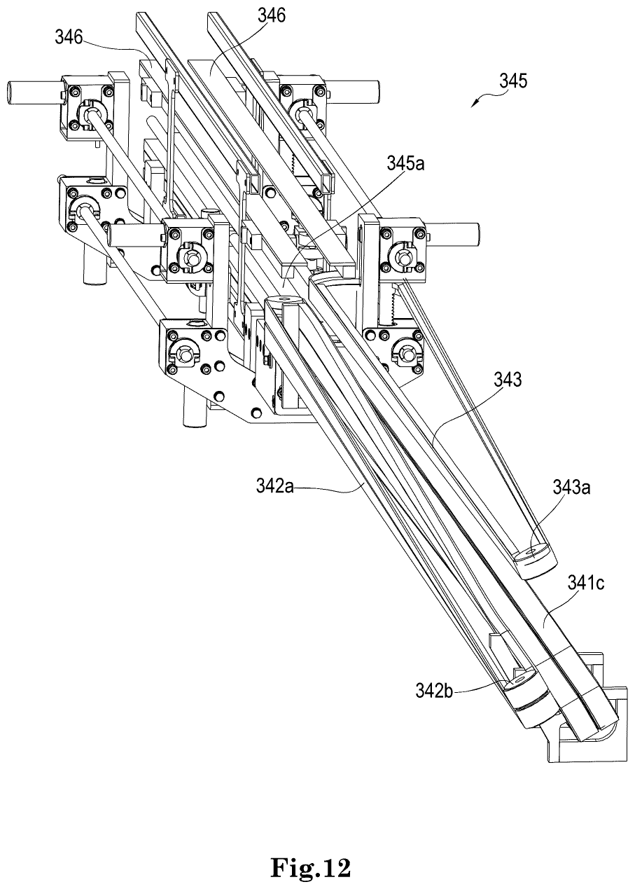

FIG. 12 shows a perspective view of a preferred embodiment of an extraction transport system for transporting closing elements in the form of triggers;

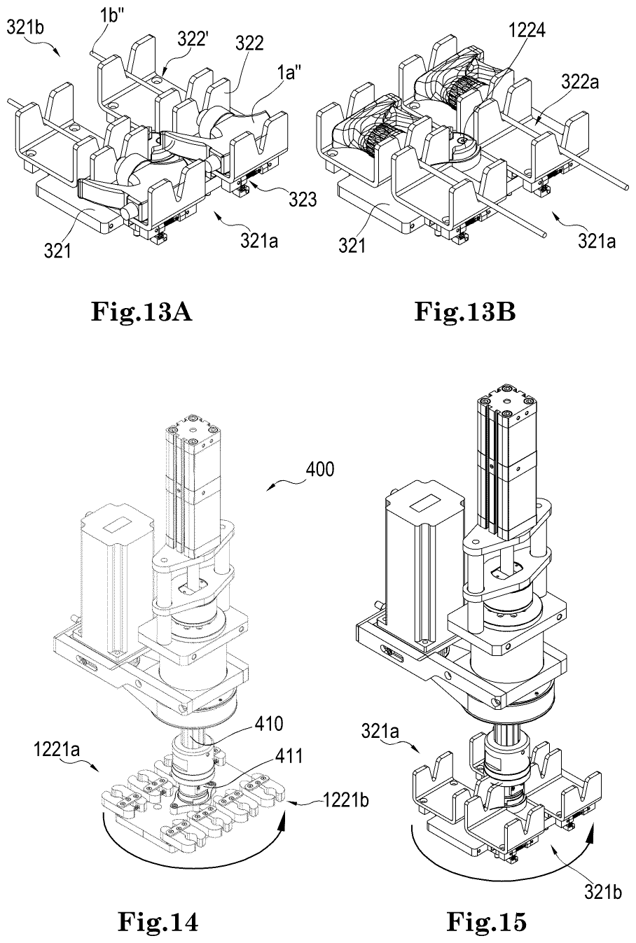

FIGS. 13A, 13B show a support plate which carries a plurality of trigger-holder trays, with seats for holding different trigger formats; and

FIGS. 14-15 show perspective views of an auxiliary device for rotation of the support plates according to FIGS. 4,13A, 13B.

With reference to FIGS. 1-2 and assuming solely for the sake of easier description and without a limiting meaning, a set of three axes, i.e. longitudinal lengthwise axis X-X, transverse widthwise axis Y-Y, and vertical axis Z-Z, perpendicular to the preceding axes, a first embodiment of a sorting apparatus 100 for sorting randomly fed closing elements 1 comprises an input conveyor plane 110 which transports in a longitudinal feeding direction x1 a plurality of closing elements which advance randomly arranged on the conveyor plane 110 from upstream to downstream.

The plane 110 may for example consist of the movable surface of a conveyor belt which supports and transports the closing elements, for example actuated by suitable motor-driven rollers. It is understood that the longitudinal feeding direction x1 could also not be straight over its entire length, but comprise one or more bends.

One or more pick and place devices 130 are arranged at the conveyor plane 110 and controlled to pick up a closing element 1′ from the input conveyor plane and position it in an intermediate transport system 220 with a predefined intermediate position and/or orientation. The transport system according to the present invention may be advantageously used as an intermediate transport system in a sorting method according to the present invention and, below, preferred embodiments of the transport system will be described with reference to sorting apparatus of this type. It is however clear to the person skilled in the art that the transport system according to the present invention may be used also in other apparatus for transporting closing elements.

The intermediate transport system 220 is arranged alongside, in the transverse direction Y-Y, a section of the input conveyor belt 110.

With reference to FIGS. 2 and 3, the intermediate transport system 220 is arranged and configured to receive closing elements 1′ and to feed them to the input of an extraction system 240 configured to output an orderly flow of closing elements 1′, arranged with a predefined extraction position and/or orientation.

The pick and place devices 130 advantageously are arranged and can be controlled to pick up one of said closing elements 1′ arranged randomly on the input conveyor plane 110 and position it in the intermediate transport system 220, with a predefined intermediate position and/or orientation.

A detection system 60 is designed to detect the position and orientation of closing elements 1′ in transit on the input conveyor plane and to make the information available to a processing and control unit 500 (shown only in schematic form) for controlling the pick and place devices 130. The devices 130 are therefore controlled so as to perform the picking up of a closing element and movements for (re) orientation and positioning thereof so as to position it in the intermediate transport system 120 with the predefined intermediate position and/or orientation. The movements may be different depending on the detected position and arrangement of the closing element.

In the preferred embodiment shown, said system 60 comprises at least one telecamera 61,62 arranged upstream of an associated pick and place robot 131, 132 in the direction of feeding x1 on the transport plane 110. Each telecamera is designed to detect the position and arrangement of the closing elements 1 in transit on the transport plane within its viewing field, making the information available for controlling the operation of the respective robot 131,132. Telecameras of this type are known in the sector of sorting machines and are not described in greater detail.

The detection system 60 may preferably comprise also means for measuring the advancing movement of the transport plane, for example comprising an encoder associated with the means for moving the conveyor belt.

The intermediate transport system 220 is in the example configured to transport closing elements 1′ with a sprayer. For this purpose, it comprises a plurality of holding elements 222 for holding a respective closing element 1′, in this case configured to hold the neck In situated underneath the head 1a′ of a sprayer 1′, arranged in a vertical upright position with the head 1a′ at the top. In the preferred example shown, the front side F is directed towards the outside of the intermediate transport system 220. The holding elements 222 are movable between a positioning zone 220a for positioning by the devices 130 and an exit part situated in correspondence of an input 241a of the output extraction system 240.

In greater detail, the holding elements 222 move along a circuit 225 between the positioning zone 220a and the input 241 of the extraction system 240. The circuit 225 is preferably an oval (or closed loop) circuit with straight sections, i.e. an outward section 225a, which includes the positioning zone 220a, and return section 225b, which passes by the input 241a of the extraction system 240. The straight sections 255a,255b are connected by curved joining sections 225c.

The movement trajectory along the circuit lies preferably in a plane parallel to the input plane 110 and/or to one of the output extraction planes 145,245. The direction along the output section 225a is in the example parallel to the longitudinal extraction direction x2, and the direction x3 along the return section 225b is parallel to the longitudinal direction x1 for feeding of the elements on the input plane 110. Along the straight sections, the holding elements are in particular arranged at predetermined regular intervals.

As shown, the closing elements therefore rotate through 180 degrees about a vertical axis between the position at the input 220a into the intermediate system 220 and the input 241a into the extraction system.

Each holding element 222 is in the form of a gripper configured to hold the neck In of the sprayer. Each holding element 22 may in particular comprise a pair of oppositely arranged jaws 222a. The jaws 222a are preferably coupled together with interposed resilient means 222c (FIG. 6) designed to bias them towards a relative closing position for holding the neck of the sprayer. For positioning by the pick and place devices 130, it may be sufficient to insert the closing element 1′ between the jaws of the gripper 222, with a slight pressure by the closing element 1′ moved by the robot 131 so as to cause the temporary spreading of the jaws 222a, against the action of the resilient means 222c.

As shown in FIGS. 2 and 3, the intermediate transport system 220 comprises a plurality of support elements 221, in particular support plates 221, movable along said circuit between the positioning zone 220a and the input 241 of the extraction system 240.

Each gripper 222 is mounted cantilevered on one of the movable supports 221. Preferably, each support 221 comprises a plurality of holding elements 222 arranged at predefined regular intervals along an operating side thereof.

The holding elements 222 may be configured to hold closing elements 1a′ with different formats. The grippers 222 are in fact particularly suitable for holding the neck 1n of the sprayers, which is generally cylindrical, also upon variation of the outer form of the overlying head 1a′. The two jaws may define between them a vertical axis seat which is suitably shaped to hold the neck In of the closing element.

Moreover, as will be described below with reference to FIGS. 4-6, each support 221 preferably carries a plurality of holding elements 222 designed to hold closing elements with different formats, for example by means of different prestressing of the resilient means 222a and/or by means of jaws 222a of the grippers 222 realized with different forms and dimensions suitable for gripping different sprayer formats.

The extraction system 240 is designed to receive at its input 241a the closing elements 1′ transported by the intermediate system 220 and to output an orderly flow of closing elements 1′ arranged with a predefined extraction position and/or orientation, which in the preferred example shown is an upright position with the head 1a′ directed upwards and rear side directed in the advancement direction x2 for output from the extraction system 240. Said extraction position and orientation is particularly advantageous for extracting closing elements of the sprayer type 1′.

The extraction system 240 shown comprises a transition assembly 241 which intercepts at its input 241a the sprayers 1a′ transported by the holding means 22 and outputs them to an output conveyor 245 which is generally in the form of a longitudinal/transverse transport plane 245 formed with two extraction side shoulders arranged opposite each other in the transverse direction, the upper transport half-planes 245a,245b thereof supporting a bottom surface of the head 1a′ of the sprayer, and a central cavity which allows the bottom vertical stem 1b′ to pass through.

The transition assembly 241 comprises a star wheel 242 rotating about a vertical axis and provided with a plurality of vertical-axis seats 242a for housing a respective closing element 1′, the seats being arranged at a predefined angular distance from each other along a circumference. Each seat 242a is designed to house a part (generally with a larger diameter) of the head 1a′ of the sprayer 1′ different from that held by the grippers 222. The angular distance between the seats 242a and the direction and speed of rotation of the star wheel 242 are suitably configured to intercept the closing elements 1a′ carried by the grippers 222 when they pass by the input zone 241a, capturing them inside a respective seat of the rotating star wheel.

A curved guide 243 is arranged in a position radially on the outside of the star wheel 242 between the input position and the output towards the extraction plane 245, in order to contain and guide the sprayers 1′ arranged inside the seats during rotation. The guide 243 has a projecting free end 243a at the input 241a into the transition assembly, designed to channel the sprayers 1′ in transit and favour their separation from the holding means 222 as a result of the action of the rotating star wheel 242. The opposite end of the guide 243 is instead arranged in the proximity of the input to the extraction plane 245.

Should the extraction direction x2 for extracting the closing elements 1′ in the extraction system and the longitudinal direction of advancing movement of the holding means 222 to the input 241a in the extraction system (therefore along the return branch 225b) be concordant, the transition assembly 240 could consist of a simple grooved guide, for example in the form of an S, suitable for intercepting the sprayers 1′ in transit and channelling them towards the extraction plane 245. Owing to the intermediate transport system 220 according to the invention, it is in fact generally not necessary to change the position of the sprayers 1′ by means of rotation about axes different from the main vertical axis, between the intermediate position and the final extraction position.

It is therefore clear how the intermediate transport system 220 and the extraction system 240 allow the sorting of closing elements of the sprayer 1′ type.

The input plane 110, the intermediate system 220, the robots 130 and the extraction system 240 form in particular a sorting line for sorting closing elements 1′, wherein the method for sorting the elements 1′ randomly arranged on the conveyor plane 110 into the orderly flow with a desired extraction position and/or orientation is regulated by the combination of the orientation and position settings of the robots 130 for the intermediate position/orientation and by the configuration of the holding means and of the extraction system 240.

FIGS. 4 to 6 show a particularly preferred example of the support plate 1221, which comprises a plurality of holding elements 222, 222′ arranged at regular intervals on a first longitudinal side 1221a of the support plate 1221. As shown in FIG. 5, advantageously, only some 222′ of said holding elements may be designated as active for sorting, for example depending on a desired pitch for entry 241a into the extraction system 240. In use, the control unit 500 will control the pick and place robots 130 so that they position the closing elements 1′ only in said holding elements 222′ which are designated as active.

Furthermore, these holding elements 222,222′ are preferably arranged in the manner of at least two series of holding elements, with the grippers 222 of the first series arranged alternating with the grippers 222′ of the second series of holding elements. As shown in FIG. 5, each series of holding elements 222,222′ may be adapted or designated to hold closing elements 1′ with a different format. Preferably, the support has a second longitudinal side 1221b, opposite to the first side 1221a.

One or more series of holding elements are arranged on the first side 1221a and one or more additional series of holding elements for holding different closing elements are arranged at regular intervals on the second side 1221b. Therefore, during use, the plate 1221 will have an operative side which receives and holds the closing elements 1′, directed towards the outside of the intermediate transport system 220, and an opposite standby side, directed towards the inside. Although illustrated as being identical, it is understood that the grippers 222,222′ of one series will be preferably different from those of another series.

The plate furthermore comprises coupling means 1224 for coupling to an auxiliary device for rotation of the plate 1221 about a vertical axis, which will be described in greater detail below with reference to FIGS. 12-13.

As can be seen in FIG. 6, the supports 1221 with multiple holding elements 222,222′ are therefore particularly versatile for managing different formats of closing elements 1′ and/or different parameters of the sorting and extraction process, without the need for complicated replacement of the holding elements 222.

With reference to FIGS. 7 and 8, the plates 1221 are mounted on respective carriages which move on a guide which defines the oval circuit of movement of the plates.

Each plate 1221 is provided with means (not shown) for coupling to the respective carriage, which are configured to switch between a first operative position, in which the plate is rigidly secured to the carriage, and a second position, in which the plate 1221 is coupled to the carriage with the possibility of rotating about a vertical axis perpendicular to the plane of the plate. Preferably, the mechanism for coupling together plate and carriage is such that, by exerting a downwards pressure on the plate, it switches from said first operative position into said second operative position, in which it may rotate with respect to the carriage without however being disengaged therefrom.

The plates 1221 are moved along the circuit by actuating means; for example, in the embodiment shown, the carriages are provided with roller wheels which engage with the oval guide and are attached to a belt moved by a motor-driven pulley. In this embodiment the carriages are therefore not independent of each other.

In a variation of embodiment, the carriages may instead by moved individually along the oval guide by means of independent actuating means which are controlled by the central control unit 500 which is also preferably designed to vary the speed of advancing movement of the said carriages along the different sections of the guide. In an example of embodiment, each plate is coupled to a carriage which includes permanent magnets, and the system for actuating the carriages comprises a linear motor comprising electric windings integral with the fixed guide and preferably extending along the whole length of the guide. With this configuration, the magnets and therefore the carriages are moved and controlled in terms of position and speed by the magnetic field generated by the aforementioned fixed windings.

As can be seen in FIG. 8, in the example shown only the second and the fourth holding element 222 of each plate 1221 are used, forming a second series of holding grippers arranged at regular intervals in the positioning zone 1220a and along the straight section of movement towards the input 241a of the extraction system 240.

As shown in FIG. 8, it is envisaged that, in preferred embodiments of the extraction system 140,240 for output transportation, the extraction conveyor plane 145,245 comprises vertical containing side shoulders 246 which extend parallel to the advancement direction x2 of the closing elements 1′ being extracted, at a height above the extraction plane 245. The containing side shoulders 246 are designed to reduce the possibility of the closing elements 1,1′ falling/being overturned at the moment of their entry into the extraction plane and/or during advancement towards the output. The two opposite shoulders may be movable and/or motorized so that they can be displaced in the transverse direction Y-Y and/or vertical direction in order to adjust the interaxial distance to the actual corresponding transverse dimensions of the different closing elements.

With reference to FIGS. 9 and 10, an embodiment of the sorting apparatus 300 of the present invention comprises a different intermediate transport system 320 according to the present invention, arranged and configured to receive closing elements 1″ of type or format different from that of the sprayers 1′, in particular of the type with a head 1a″ provided with a trigger on a front side F thereof.

The extraction system 340 is in turn configured to output an orderly flow of closing elements 1″, arranged with a predefined extraction position and/or orientation, which in the case of triggers 1″ is preferably an upright vertical position, with the head 1a″ oriented downwards and the rear side B directed forwards in the extraction advancement direction x2.

The intermediate transport system 320 is configured to transport the closing elements 1″ of the trigger type from a positioning zone 320a, in which they are positioned by the robots 130, to an exit part for output towards an input 341a of the extraction system. For this purpose, it comprises (FIGS. 9,10,11A, 11B) a plurality of holder elements 322 for holding a respective closing element 1″, in this case configured to hold the trigger 1″ in a position laid flat with the head 1a″ directed towards the outside of the intermediate transport system 320. The triggers 1″ are in particular laid flat with a side surface thereof on a substantially longitudinal/transverse plane, with the rear side B directed in a same direction, in particular forwards, relative to a direction of advancement in the intermediate transport system 320.

The holding elements 322 are movable between the positioning zone 320A and the exit zone for output towards the input 341a of the output extraction system 340.

In a manner similar to that described above, the holding elements 322 move preferably along an oval circuit 325 between the positioning zone 320a and the input 341a of the extraction system 340. In this example of embodiment, the direction of advancement along the outward section is parallel to and in the same sense as the longitudinal direction x1 of feeding of the elements on the input plane 110, and the direction along the return section is parallel to and in the same sense as the longitudinal direction x2 of advancement in the extraction system. Along the straight sections of the circuit, the holding elements 322 are in particular arranged at predetermined regular intervals.

As shown in FIGS. 10 and 13A, each holding element is in the form of a tray 322 which defines a compartment 322a for housing the closing element 1″ which is open upwards. In particular, the tray has a substantially U-shaped form with a bottom resting plane for the head 1a″ of the trigger 1″ and two opposite vertical containing walls projecting upwards from the bottom plane and situated opposite each other in a transverse direction, parallel during use to the direction of the main axis (of the stem 1b″) of the closing element 1″. At least the internal wall is fork-shaped with a vertical recess designed to allow insertion and holding of the stem 1b″ of the trigger 1″.

The support plane of each tray is coupled to a support plate 321 by means of hinging means 323 for rotation about a longitudinal axis, configured to allow rotation of the tray 322 from the holding position into an overturned position, where the triggers 1″ fall by means of gravity towards the input 341a of the extraction system 340, in a position rotated about the longitudinal axis through an angle greater than or equal to 90 degrees. These hinging means 323 comprise for example a hinge with longitudinal pin.

The guide of the movement circuit 324 for the trays 322 has advantageously cam means designed to act on the tray so as to cause the overturning rotation thereof at the input 341a of the extraction system 340. For example, the cam means may include a linear cam with an upper profile which acts on a bottom surface of the tray 322. Downstream of the input 341a of the extraction system there may be present means for righting the tray, for example comprising second cam means with a profile which is the reverse of the profile of the overturning cam. In an alternative embodiment, the hinging hinge 323 may comprise resilient means, configured to cause an elastic return of the tray into the holding position, downstream of the input 341a of the extraction system.

The trays 322 are therefore arranged at predetermined regular intervals in the positioning zone 320a, where they receive a respective trigger 1″ positioned with said intermediate position and orientation by a robot 131. The trays 322 then move along the oval circuit as far as the input zone 341a of the extraction system, where they are rotationally actuated into the overturned position in which they release the triggers 1″ to the extraction system 340. In addition to the change in orientation by means of rotation through 180 degrees about the vertical axis, determined by the movement along the circuit, the closing elements 1″ are thus arranged in a second intermediate position for their entry into the extraction system 340, said position being rotated by at least 90 degrees with respect to the flat position, but not yet completely upright in the vertical direction.

The extraction system 340 for extracting and advancing the closing elements 1″ downstream is configured to receive at its input 341a the elements 1″ arranged with said second intermediate position and orientation and to output them in the extraction direction x2 so that they arranged in an orderly flow with a predefined extraction position and orientation, which is preferably a vertically upright position with the head 1a″ downwards, the stems 1b″ upwards and the rear side B directed forwards in the extraction direction x2.

The extraction system 340 comprises a transition assembly 341 which includes said input 341a where the triggers 1″ fall from the holding trays 322 into said second intermediate position and orientation.

The transition assembly 341 is configured to transport the triggers 1″, varying the position and/or orientation thereof, so as to feed them to the input of an extraction conveyor 345 with the predefined extraction position and/or orientation. The extraction conveyor 345 then outputs the orderly flow of closing elements, arranged with the predefined extraction position and/or orientation and advancing in the longitudinal extraction direction x2. In particular, the transition assembly 341 is designed to vary the position of the triggers 1″ from the second intermediate position into the predefined vertically upright extraction position by means of rotation about a longitudinal axis.

With reference to FIGS. 10-12, the preferred example of a transition assembly 341 shown comprises an inclined bottom transport plane 341c on which the triggers 1″ fall in said second intermediate position, with the head 1a″ resting on the inclined bottom plane 341c; the inclined plane 341c is arranged adjacent in the transverse direction Y-Y and underneath the holding means 322 of the intermediate transport system 320, at the input 341a of the extraction system 340.

The inclination of the bottom plane 341c varies gradually between the input 341a of the extraction system and the input of the extraction plane 345, until it becomes horizontal, namely parallel to the transverse direction Y-Y and the longitudinal direction x2 of extraction. The bottom plane 341c is preferably formed by a conveyor belt wound around rotating drive rollers, with axes of rotation respectively: inclined so as to correspond to the initial inclination of the bottom plane 341c and parallel to the transverse direction at the output of the transition assembly. The conveyor belt 341c may for example be formed by one or more belts wound around said rollers.

A first inclined side belt 342 is arranged adjacent to the bottom transport plane 341c in the transverse direction Y-Y and is designed to support laterally the closing element 1″; the side belt 342 is in particular arranged on the outside of the first plane 341c, on the opposite side to the intermediate transport system.

The inclined side belt 342 has an inclination which varies gradually between the input 341a and the output of the transition assembly. At the input 341a, the belt is inclined from the outside towards the inside in the transverse direction and from the top downwards in the vertical direction Z-Z so as to form, for example, an angle substantially at 90 degrees with the bottom transport plane 341c. In its end part which leads to the input of the extraction conveyor 345, the first side belt is oriented parallel to the vertical direction Z-Z. The side belt 342 is therefore designed to cooperate with the inclined bottom plane 341c so as to impart to the triggers 1″ a gradual further rotation about the longitudinal axis, so as to bring them into the predefined vertically upright extraction position. Said side belt 342 may be preferably in the form of one or more belts 342a wound around drive rollers 342b, acting on the cylindrical part of the head 1a″ of the trigger so as to impart to the trigger said further rotation.

Preferably, the transition assembly 341 furthermore comprises a second inclined side belt 343 arranged laterally with respect to the first inclined plane 341c on the opposite side to the first side belt 342. The second belt extends from a point downstream of the input 341c of the transition assembly, situated after the start of the bottom plane 341c and of the first side belt 342, as far as the output of said assembly which feeds the extraction conveyor 345. The second side belt 343 has an inclination which varies gradually as far as its end part which leads to the input of the extraction system, where the belt is oriented parallel to the vertical direction Z-Z. The inclination of the third belt may be substantially parallel to the inclination of the first side belt 342. Said second side belt 343 may be preferably in the form of a belt wound around a drive roller 343a.

With reference to FIG. 12, the output conveyor 345 may be in the form of a conveyor belt 345a which defines a longitudinal/transverse extraction plane, with vertical side shoulders 346,347 which laterally contain the triggers 1″ for transportation in the longitudinal extraction direction x2 in the vertical upright position with the head at the bottom.

In greater detail, the extraction conveyor 345 may include a pair of containing side shoulders 346 arranged opposite each other in the transverse direction and arranged on opposite sides of a line of advancement of the closing elements along the conveyor plane 345. The shoulders are mounted on vertical uprights movable in the vertical direction and/or transverse direction in order to adjust the height and the distance of the pair of containing shoulders 346. In the case of trigger-type closing elements 1″, preferably the shoulders are arranged so as to contain the closing element both laterally and from above, with respective containing planes arranged laterally and above the closing element.

With reference to FIGS. 13A, 13B and in a manner similar to that shown with reference to the support plate 1221 shown in FIGS. 4-6, the support 321 for carrying the trays 322 has preferably a first longitudinal side 321a along which a series of holding trays 322 are hinged at a regular distance and a second longitudinal side 321b, opposite to the first side 1221a in the transverse direction, along which a further series of holding trays 322′ are hinged at a regular distance. Preferably, each support 321 carries two or more trays 322 on each side.

Therefore, during use, the support plate 321 will have an operative side 321a which receives and holds the closing elements 1″ in the trays 322 hinged therewith and which is directed towards the outside of the intermediate transport system 320 in the transverse direction, and an opposite standby side, directed towards the inside. Although shown as being identical, it is understood that the seats defined by the trays 322,322′ of the two sides 321a,321b are preferably different, so as to hold triggers 1″ with a different format, as schematically shown in FIG. 11B. In a further preferred embodiment, the trays 322 are configured with adjustable size seats; for example, one or both the vertical walls of each seat may be movable towards or away from each other in order to adjust the size of the respective seat.

The support plate 321 also furthermore comprises means 1224 for coupling to an auxiliary device for rotation of the plate 321 about a vertical axis, which will be described in greater detail below with reference to FIGS. 14-15.

With reference to FIGS. 14 and 4-6, each support 1221 carrying holding means 220 is preferably provided with coupling means 1224 designed to be engaged by rotation means of a device 400 for gripping and rotating the support 1221. In the example shown, these coupling means 1224 are in the form of a disc mounted on the top surface of the support plate 1221, in a substantially central position, and provided with a pair of shoulders projecting upwards in the vertical direction Z-Z, preferably with a curved profile.

The gripping and rotation device 400 comprises in particular an arm 410, the bottom end of which is movable in both senses of the vertical direction Z-Z between a raised position and a lowered position for engagement with the plate 1221, upon control of actuating means, for example of the electric actuator type. The bottom end of the arm 410 is provided with a rotating spindle 411, configured with engagement means for coupling with the coupling means 1224 of the plate 1221, against which it stably engages.

During use, the device 400 may be arranged in a predefined position along the circuit 225 for movement of the supports 1221 or be displaceable from a position outside the circuit into a position situated above the circuit, by means of a corresponding actuating means.

Once the plate 1221 is positioned in a coaxial position underneath the rotating spindle 411, the arm 410 is actuated into the lowered position, resulting in coupling of the engagement means with the coupling means 1224 of the plate 1221.

The engagement means may be designed to expand radially in order to cause the stable gripping of the projecting shoulders of the coupling means 1224 of the plate 1221, actuated by a respective actuating device.

Once the plate 1221 is engaged, the spindle 411 is lowered further, switching the mechanism for coupling the support plate 1221 to the carriage, by means of which it is mounted on the guide 225, into the second operative position in which the plate is coupled to the carriage with the possibility of rotating about a vertical axis.

The spindle 411 is then rotationally actuated about the vertical axis (FIG. 14) so as to rotate the plate 1221, for example through 180 degrees, so as to bring the side 1221b, which was previously in the standby position, into the operative position. In this way, the holding jaws 222,222′ on the standby side are made operative for holding closing elements with a different format.

With reference to FIGS. 13A, 13B and 15, the support plates 321 which carry the trays 322 for holding the triggers 1″ may be rotated in a similar manner, so as to arrange the standby side 321b, which has compartments for holding different-format triggers 1″, into the operative position.

Therefore, by means of the assembly consisting of the support plates 1221, 321 with coupling means and the device for rotation of the plates 400, it is possible to carry out in a quick and easy manner a process for changing the format of the apparatus in order to sort closing elements with a different format.

According to preferred embodiments it is envisaged that the pick and place robots 131, 132 have a number of axes of rotation and/or degrees of freedom less than or equal to five, so as to be able to simplify the orientation and positioning movements of the closing elements and therefore ensure a high speed and efficiency of the picking-up and placing in the intermediate transport system. Owing to the versatility of the intermediate transport system and extraction systems during reorientation and positioning of the closing elements it is in fact not necessary for the robots 130 to perform, prior to release, complicated movements for orientation and positioning of the articles, said operations being time-consuming and penalizing the performance of the sorting machine, as well as resulting in the need to use complex and costly robots which may also require more than five degrees of freedom and/or axes of rotation.

Although described in connection with a number of embodiments and a number of preferred examples of implementation of the invention, it is understood that the scope of protection of the present patent is determined solely by the claims below.

1-36. (canceled)

37. A sorting method for sorting closing elements for closing containers, comprising:
transporting a plurality of closing elements, arranged randomly on an input conveyor plane;
picking up a plurality of the closing elements arranged randomly on the input conveyor plane by means of one or more pick and place devices and positioning the picked-up closing elements with a predefined position and/or orientation in a positioning zone of a transport system for transporting closing elements, where they are received by a respective holding element of a plurality of holding elements for holding a closing element;
transporting the closing elements held by the holding elements to an exit part of the transport system;
wherein the transport system comprises a plurality of support elements which each have a plurality of said holding elements, mounted on the support element and arranged at predetermined intervals along at least one side of the support element;
wherein the support elements and the holding elements move along an oval circuit between the positioning zone and the exit part
wherein each support element comprises a plurality of holding elements arranged at predetermined intervals on two opposite sides, wherein, during use, one of the opposite sides is operative and the other one is on standby.

38. The sorting method according to claim 37, wherein the holding elements are arranged on the respective support as a first series and at least one second series of holding elements;
and wherein the pick and place devices are controlled so as to use a different series of holding elements for holding closing elements of a different format and/or for varying a pitch between the closing elements transported in the transport system.

39. The sorting method according to claim 38, wherein the holding elements of the second series are adapted and/or designated to hold closing elements of a different format from that of the holding elements of the first series.

40. The method according claim 37 further comprising:
carrying out a format change of the transport system so as to transport a plurality of closing elements of a different format, by designating for each support element a different series of holding elements for holding the different closing elements and/or for varying a pitch between the closing elements transported in the transport system.
transporting a plurality of closing elements of a different format, arranged randomly on the input conveyor plane;
picking up a plurality of the closing elements of a different format arranged randomly on the input conveyor plane by means of one or more pick and place devices, and positioning the picked-up closing elements with a predefined position and/or orientation in the positioning zone of a transport system for transporting closing elements, where they are received by a respective holding element of the holding elements of said different series of holding elements for holding a closing element with a different format;
transporting the closing elements of a different format held by the holding elements to the exit part of the transport system.

41. The method according to claim 37, wherein the plurality of closing elements comprises closing elements of the sprayer type format, which has a top head with dispenser, a neck situated underneath the head and a bottom stem extending along a main vertical axis.

42. The method according to claim 41, wherein the holding elements hold a neck situated underneath the head of a respective sprayer arranged in a vertical upright position with the head at the top.

43. The method according to claim 37, wherein the plurality of holding elements comprises closing elements of a format having a top head with trigger and a bottom stem extending parallel to a main axis of the holding element.

44. The method according to claim 43, wherein said closing elements with trigger head are held in a position laid flat with the head directed towards an outside of the transport system.

45. A sorting apparatus for sorting closing elements, comprising:
an input conveyor plane for transporting a plurality of closing elements arranged randomly on the conveyor plane;
a transport system for transporting closing elements, comprising a plurality of holding elements for holding a closing element, movable between a positioning zone, where they receive a closing element positioned with a predefined position and/or orientation, and an exit part for extraction of the closing elements;
one or more pick and place devices, arranged and controllable so as to pick up a closing element arranged randomly on the input conveyor plane and to position it with a predefined position and/or orientation in the positioning zone of the transport system, where it is received by one of the holding elements;
a control unit;
wherein the holding elements move along an oval circuit between the positioning zone and the exit part;
and wherein the transport system comprises a plurality of support elements movable along said oval circuit between the positioning zone and the exit part, wherein each holding element is mounted on one of said supports and each support has a plurality of said holding elements, arranged at predetermined intervals along a side thereof
wherein—each support element comprises a plurality of holding elements arranged at predetermined intervals on two opposite sides, wherein, during use, one of the opposite sides is operative and the other one is on standby.

46. The apparatus according to claim 45, wherein the control unit is configured to designate as active for sorting only some of said holding elements and to control the pick and place devices so that they position the closing elements only in said holding elements designated as active.

47. The apparatus according to claim 46, wherein the holding elements are arranged on the respective support in the manner of a first series and at least one second series of holding elements,
and wherein the control unit is configured to:
designate as active only the holding elements of the first series and to control the pick and place devices so as to use only the first series of holding elements for holding closing elements of a first format and/or for setting a first pitch between closing elements transported in the transport system; and
designate as active only the holding elements of a different series and to control the pick and place devices so as to use only the different series of holding elements for holding closing elements of a different format and/or for varying the pitch between closing elements transported in the transport system.

48. The apparatus according to claim 47, wherein the holding elements of the second series are adapted and/or designated by the control unit to hold closing elements of a different format from that of the holding elements of the first series.

49. The method according to claim 37, wherein the oval circuit comprises a straight outward section which includes the positioning zone, and a straight return section, which includes the exit part, said sections being connected by curved joining sections

50. The method according to claim 37, wherein said support elements are support plates movable along said circuit between the positioning zone and the exit part.

51. The method according to claim 37, wherein the support elements move on a fixed guide which defines said oval circuit.

52. The method according to claim 37, wherein said support elements, in particular said support plates, are mounted on respective carriages which move on a guide which defines the circuit for movement of the support elements, and each comprise coupling means for coupling with the respective carriage.

53. The method according to claim 52, wherein the coupling means for coupling to the carriage are configured to switch between a first operative position, in which the support element is rigidly secured to the carriage, and a second position, in which the support element is coupled to the carriage with the possibility of rotating about a vertical axis.

54. The method according to claim 53, wherein said coupling means are configured so that, by exerting a downwards pressure on the support element, they switch from said first operative position to said second operative position.

55. The method according to claim 37, wherein said support elements, in particular said, support plates each comprise coupling means for engagement, with an auxiliary device for rotating the support element about a vertical axis.

56. The method according to claim 55, further comprising an auxiliary device for gripping and rotating the support elements comprising an arm, the bottom end of which is movable in both senses of the vertical direction (Z-Z) between a raised position and a lowered position for engagement with a support element, and is provided with rotating means configured for stable coupling with the coupling means of the support element and able to be operated rotationally so as to rotate the element about a vertical axis in order to vary the arrangement thereof on the oval circuit.

57. The method according to claim 56, wherein the auxiliary device is arranged in a predefined position along the movement circuit of the supports or is displaceable from a position outside the circuit to a position situated above the circuit, by means of actuating means.

58. The method according to claim 56, wherein the auxiliary device for rotating the support element is configured to operate in the vertical direction on the support element so as to switch between the first and second operative position the coupling means of the support element for coupling to the carriage.

59. The method according to claim 37, wherein a plurality of said holding elements is each in the form of a gripper comprising a pair of opposite jaws; the jaws being preferably coupled together with interposed resilient means designed to bias them towards a relative closing position for holding the closing element.

60. The method according to claim 37, wherein a plurality of said holding elements for holding a closing element are in the form of a respective tray which defines an upwardly open compartment for housing the closing element.

61. The method according to claim 60, wherein the tray has a substantially U-shaped form, with a bottom plane for supporting the head of the closing element and two opposite vertical containing walls projecting upwards from the support plane and situated opposite each other in a transverse direction, parallel during use to the direction of the main axis of the closing element, wherein at least one wall is configured with a slot for inserting and holding a stem of the closing element.

62. The method according to claim 59, wherein, in order to release the closing elements at the exit part, each tray is provided with hinging means (323) for rotation about a longitudinal axis, configured to allow rotation of the tray (322) from a holding position into an overturned position, whereby the closing elements (1″) fall by means of gravity into a position rotated about a longitudinal axis through an angle greater than or equal to 90 degrees.

63. The method according to claim 62, wherein cam means are designed act on the tray in said exit part so as to cause an overturning rotation thereof and wherein, downstream of the exit part, means are arranged for righting the trays.

64. The method according to claim 63, wherein the means for righting the trays comprise second cam means with a profile which is the reverse of that of the overturning cam means or resilient means, configured to cause the elastic return of the tray into the holding position.

65. The method according to claim 37, wherein the closing elements are rotated through 180 degrees about a vertical axis when they are transported from the positioning zone at the input to the exit part for extraction.

66. A transport system for transporting closing elements for an apparatus for sorting closing elements, comprising a plurality of holding elements for holding a closing element, movable between a positioning zone, where they receive a closing element positioned in a predefined position and/or with a predefined orientation, and an exit part for extraction of the closing elements; wherein the holding elements move along an oval circuit between the positioning zone and the exit part; the transport system further comprising a plurality of support elements, in particular support plates, movable along said circuit between the positioning zone and the exit part,
wherein each holding element is mounted on one of said supports and each support has a plurality of said holding elements, arranged at predetermined intervals along one side thereof,
and wherein a plurality of the holding elements for holding the closing elements are arranged in the manner of at least a first series and a second series of holding elements, with the holding elements of the second series being adapted to hold closing elements of a different format from that of the holding elements of the first series, and
wherein each support element comprises a plurality of holding elements arranged at predetermined intervals on two opposite sides, wherein, during use, one of the opposite sides is operative and the other one is on standby.

67. The transport system according to claim 66, wherein the holding elements of said first series are each in the form of a gripper comprising a pair of opposite jaws adapted for holding a closing element of a sprayer type format, which has a top head with dispenser, a neck situated underneath the head and a bottom stem extending along a main vertical axis; the jaws being preferably coupled together with interposed resilient means configured to bias them towards a relative closing position for holding the closing element.

68. The transport system according to claim 66, wherein the holding elements of said second series are in the form of a respective tray which defines an upwardly open compartment suitable for housing a closing element of a format having a top head with trigger and a bottom stem extending parallel to a main axis of the closing element.

69. The transport system according to claim 68, wherein the tray has a substantially U-shaped form, with a bottom plane for supporting the head of the closing element and two opposite vertical containing walls projecting upwards from the support plane and situated opposite each other in a transverse direction, parallel during use to the direction of a main axis of the closing element, wherein at least one wall is configured with a slot for inserting and holding a stem of the closing element.
